(19) United States
(12) Patent Application Publication
(10) Pub. No.: US 2015/0195183 A1
(43) Pub. Date: Jul. 9, 2015

(54) METHOD AND APPARATUS FOR MANAGING FLOW TABLE

(71) Applicant: ELECTRONICS AND TELECOMMUNICATIONS RESEARCH INSTITUTE, Daejeon (KR)

(72) Inventors: Sae Hyong PARK, Daejeon (KR); Sae Hoon KANG, Daejeon (KR); Byung Joon LEE, Daejeon (KR); Ji Soo SHIN, Daejeon (KR)

(21) Appl. No.: 14/589,077

(22) Filed: Jan. 5, 2015

(30) Foreign Application Priority Data
Jan. 6, 2014 (KR) 10-2014-0001470
Jul. 22, 2014 (KR) 10-2014-0092606

(51) Int. Cl. H04L 12/755

(52) U.S. Cl. CPC H04L 45/021

(57) ABSTRACT

A method and apparatus for managing a flow table is provided. The method includes dividing a flow table into a plurality of states according to occupancy levels of the flow table in a network device; and managing the flow table by reflecting the changed state of the flow table.

### CROSS-REFERENCE TO RELATED APPLICATION(S)

This application claims priority from Korean Patent Application Nos. 10-2014-0001470, filed on Jan. 6, 2014, and 10-2014-0092606, filed on Jul. 22, 2014, in the Korean Intellectual Property Office, the entire disclosures of which are incorporated herein by references for all purposes.

### BACKGROUND

1. Field

The following description generally relates to a software defined network, and more particularly to a technology for flow processing and table management in a software defined network.

2. Description of the Related Art

In software defined networking (SDN), the data plane and the control plane in a network are separated. The data plane inquires of the control plane regarding decisions required for packet processing in a centralized manner. In SDN, the data plane typically refers to SDN switches, and the control plane refers to a controller that manages the entire network.

In SDN technology, the control plane of a network is focused on the SDN controller, thereby enabling packet transmission to be controlled through software. Considering a current structure of a flow table of an SDN switch, there is a limitation on the number of flow entries. Thus, various methods of managing flow tables are required to be applied for smooth communications depending on an occupancy level or a vacancy level of a flow table. However, as a flow table of a current SDN switch is in an initial development phase, only one method of managing a flow table may be applied, such that it is not possible to respond effectively to various occurrences in a network according to changes in an occupancy level or a vacancy level, thereby disrupting network services or causing significant failures.

### SUMMARY

Provided is a method and apparatus for managing a flow table, in which a flow table of an SDN switch, which is an SDN data plane, may be efficiently managed.

In one general aspect, there is provided a method for managing a flow table, the method including: dividing a flow table into a plurality of states according to occupancy levels of the flow table in a network device; receiving notification of a state change of the flow table from the network device; and managing the flow table by reflecting the changed state of the flow table.

The dividing of the flow table into the plurality of states may include dividing the flow table into a plurality of zones, and setting thresholds for each of the zones. The dividing of the flow table into the plurality of states may include configuring each of the zones of the flow table to have a pair of an upper threshold limit and a lower threshold limit.

The receiving of the notification of the state change may include, in response to an occupancy level of the flow table reaching a predetermined upper threshold limit, receiving a message notifying that the upper threshold limit is reached from the network device. The receiving of the notification of the state change may include, in response to an occupancy level of the flow table reaching a predetermined lower threshold limit, receiving a message notifying that the lower threshold limit is reached from the network device.

The receiving of the notification of the state change may include, in order to prevent jitter, not receiving the notification of the state change from the network device in a case where the network device does not trigger the notification of the state change unless upper threshold has been countered by lower threshold pair and vice versa.

The method for managing a flow table may further include: in response to a state change of the flow table, determining a management mechanism of flow entries included in the flow table according to the changed state; and transmitting an instruction including the determined management mechanism to the network device.

The method for managing a flow table may further include adjusting a timeout of flow entries or flushing out flow entries according to occupancy levels of the flow table. The method for managing a flow table may further include managing flow entries based on usage frequency of flow entries according to occupancy levels of the flow table. The method for managing a flow table may further include managing flow entries based on an age of flow entries according to occupancy levels of the flow table.

The method for managing a flow table may further include inserting a new flow entry between inactive (i.e., replaceable) flow entries and active flow entries that are classified according to usage frequency or hit rate.

The method for managing a flow table may further include setting characteristics of flow entries included in the flow table in the network device; dividing the flow table into a plurality of states according to occupancy levels of the flow table; and determining characteristics of the set flow entries by reflecting states of the divided flow table.

The setting of the characteristics of the flow entries may include: setting a hard timeout during which used flow entries remain in the flow table; and setting an idle timeout during which unused flow entries remain in the flow table.

The setting of the characteristics of the flow entries may include: in response to a flow entry that matches a received packet being present in the flow table, increasing usage frequency of the flow entry; and initializing or reducing the usage frequency of the flow entry after an elapse of a predetermined time period. The setting of the characteristics of the flow entries may further include: setting the flow entry as an active flow entry in response to the usage frequency of the flow entry being greater than a predetermined active value according to an increase and decrease of the usage frequency of the flow entry; and setting the flow entry as a replaceable flow entry in response to the usage frequency being lower than a predetermined active value.

The setting of the characteristics of the flow entries may include setting an age during which flow entries remain in the flow table.

The setting of the characteristics of the set flow entries may include, in response to a state of the flow table being changed by an increased occupancy level of the flow table, reducing a timeout of a newly added flow entry or flushing out the flow entry. The setting of the characteristics of the set flow entries may include: in response to the state of the flow table being changed from a first state to a second state by the increased occupancy level of the flow table, reducing the timeout of the newly added flow entry by a predetermined time period; and in response to the state of the flow table being changed from a second state to a third state by the increased occupancy level of the flow table, reducing the timeout of the newly added flow entry proportionately with the increased occupancy level of the flow table, or flushing out the flow entry.

In another general aspect, there is provided a method for managing a flow table, the method comprising:

dividing a flow table into a plurality of states according to occupancy levels of the flow table in a network device; and

determining processing methods by using characteristics of flow entries according to the states of the divided flow table.

The determining of the processing method of the low entries may include: in response to a state of the flow table being changed by an increased occupancy level of the flow table, identifying usage frequency of each of the flow entries included in the flow table; protecting active entries, of which the identified usage frequency is greater than a predetermined active value, and flushing out replaceable flow entries, of which the identified usage frequency is lower than the predetermined active value, or overwriting the replaceable flow entries with new flow entries.

The determining of the processing method of the low entries may include: in response to a state of the flow table being changed by an increased occupancy level of the flow table, identifying an age of each of the flow entries included in the flow table; protecting flow entries, of which the identified age is greater than a predetermined time; and flushing out flow entries, of which the identified age is lower than the predetermined time.

### BRIEF DESCRIPTION OF THE DRAWINGS

FIG. 1 is a block diagram illustrating an example of a network according to an exemplary embodiment.

FIG. 2 is a block diagram illustrating an example of an SDN according to an exemplary embodiment.

FIG. 3 is a block diagram illustrating an example of a flow table management mechanism differentiated depending on occupancy levels of a flow table according to an exemplary embodiment.

FIG. 4 is a flowchart illustrating an example of a method for managing a flow table according to an exemplary embodiment.

FIG. 5 is a flowchart illustrating a structure of a flow entry to which a timeout is applied according to an exemplary embodiment.

FIG. 6 is a graph illustrating a flow table management mechanism using an idle timeout of a flow entry according to an exemplary embodiment.

FIG. 7 is a flowchart illustrating an example of a flow entry structure to which usage frequency is applied according to an exemplary embodiment.

FIG. 8 is a graph illustrating a flow table management mechanism using usage frequency of flow entries according to an exemplary embodiment.

FIG. 9 is a diagram illustrating a flow entry structure to which an age is applied according to an exemplary embodiment.

FIG. 10 is a diagram illustrating a network device according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness,

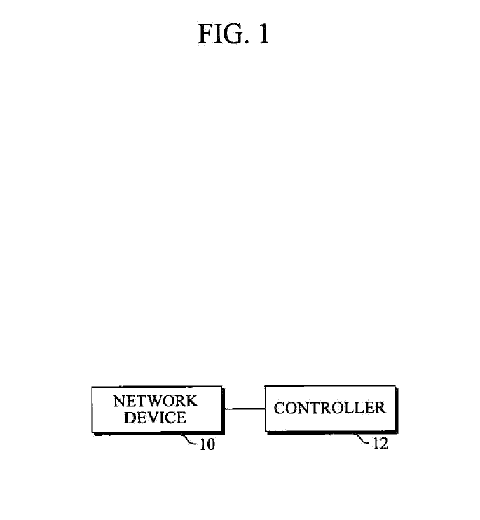

FIG. 1 is a block diagram illustrating an example of a network according to an exemplary embodiment.

Referring to FIG. 1, a network includes a network device 10 and a controller 12. In the network, communication is performed using flows, which refer to a series of flows of received and transmitted packets. The network device 10 queries the controller 12 about all the decisions required for packet processing, and the controller 12 controls network configuration and packet processing through the network device 10. A network having the above-described characteristics is called a software defined network (SDN). Hereinafter, the SDN will be described in further detail.

A network device in the SDN may be an SDN switch, and a controller may be an SDN controller. The SDN controller controls SDN switches in a centralized manner. The SDN switch may be an edge switch or a core switch that is controlled by the SDN controller. A flow refers to a series of flows of packets that are identified or distinguished by specific patterns in the packet's header fields. The flow may be defined by a specific application of an OpenFlow architecture, and in this sense, OpenFlow is one of the methods for implementing SDN.

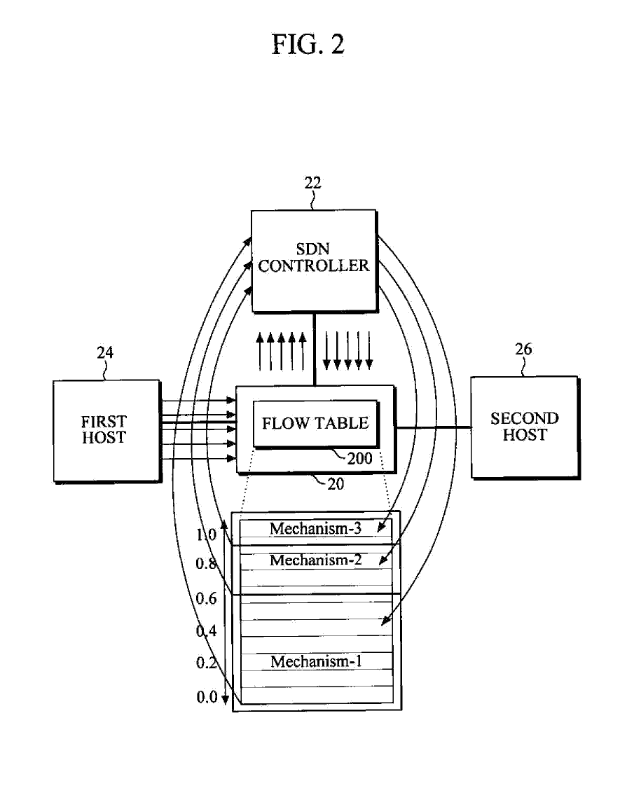

FIG. 2 is a block diagram illustrating an example of an SDN according to an exemplary embodiment.

Referring to FIG. 2, hosts 24 and 26 are connected to an SDN switch 20, and the SDN switch 20 is connected to an SDN controller 22. Although FIG. 2 illustrates only one SDN switch 20 and SDN controller 22, the example is merely illustrative for explanation, and the configuration may be further expanded.

The SDN switch 20 includes a flow table 200. The flow table 200 is a table that includes flow entries that define actions (processing information) to process packets according to rules (matching conditions). The flow entries define rules and actions defined by the OpenFlow architecture.

As defined in the OpenFlow, the flow entry rules may be defined and identified based on a destination address, a source address, a destination port, a source port, and the like included in a header field of each protocol layer of packets.

As defined in the OpenFlow, flow entry actions indicate operations, such as “output to a specific port”, “drop”, and the like. For example, if identification data of an output port is specified in flow entry actions, the SDN switch 20 outputs a packet to a port corresponding to the identification data. In a case where identification data of an output port is not specified, a packet is dropped. The SDN switch 20 performs flow entry actions for a group of packets according to flow entry rules registered to the flow table 200.

The SDN controller 22 generates flow entries and transmit the generated flow entries to the SDN switch 20. Upon receiving the flow entries, the SDN switch 20 uses the received flow entries to configure a flow table 200. It is assumed that a maximum size of the flow table 200 of the SDN switch 20 is determined to prevent capacity limitation of a memory, such as a ternary content addressable memory (TCAM), and the like, or to prevent buffer overflow.

In an exemplary embodiment, an SDN controller 22 divides the flow table 200 into a plurality of zones, and sets thresholds for each of the zones. The SDN controller 22 may make a pair of an upper threshold limit and a lower threshold limit for each of the zones. For example, based on occupancy levels of a flow table, a first zone may be configured to have a first upper threshold limit and a first lower threshold limit, a second zone may be configured to have a second upper threshold limit and a second lower threshold limit, and the third zone may be configured to have a third upper threshold limit and a third lower threshold limit. Each of the zones may or may not overlap each other. Occupancy levels of a flow table may be expressed as a percentage (%), or may be defined as a remaining space or a used space of a flow table. Setting each of the zones or setting threshold limits for each of the zones is not limited to the above exemplary embodiment, and may be changed according to network environments.

Once states of zones of the flow table 200 are changed, for example, once an occupancy level of the flow table 200 reaches a predetermined upper threshold limit of a specific zone, the SDN controller 22 changes a method of managing flow entries included in the flow table 200. To this end, every time a threshold limit of each of the zones is reached, the SDN switch 20 transmits a message that notifies reaching of a threshold limit to the SDN controller 22, and the SDN controller 22 receives a message that notifies changing of zones from the SDN switch 20. For example, if an upper threshold limit of a specific zone is reached, the SDN controller 22 may receive a message that notifies the reaching of the upper threshold limit from the SDN switch 20. In another example, if a lower threshold limit is reached, the SDN controller 22 may receive a message that notifies the reaching of the lower threshold limit from the SDN switch 20. In still another example, upon receiving a message that notifies reaching of an upper threshold limit of a specific zone, additional message that notifies the reaching of an upper threshold limit is prevented from being transmitted from the SDN switch 20 until a lower threshold limit of the specific zone is reached, thereby preventing transmission of duplicate messages.

In another example, in order to prevent jitter (i.e., transmitting excessive amount of state change notification message), the SDN switch 20 does not trigger the notification of the state change unless upper threshold has been countered by lower threshold pair and vice versa.

Upon receiving a message that notifies changing of zones, the SDN controller 22 applies a flow table management mechanism that is appropriate for a changed state to the SDN switch 20 to differently manage the flow table 200. For example, as illustrated in FIG. 2, flow table management mechanisms 1, 2, and 3 are applied according to changes of zones of the flow table 200. Flow entries constituting the flow table 200 may have characteristics, such as a flow entry timeout, a flow entry usage frequency, a flow entry age, and the like to support various flow table management mechanisms. The SDN switch 20 applies various flow table management mechanisms to the flow table 200 by using each of the characteristic or by combining the characteristics.

By applying different management mechanisms to the flow table 200, various security problems may be solved. For example, if a first host 24 is a malignant user, and carries out a flooding attack by simply changing source IP addresses to transmit packets to the SDN switch 20, all these packets are generally transmitted to the SND controller 22, and transmission from the SDN controller 22 to a flow table of the SDN switch 20 is recorded. If too much information is recorded in a flow table of the SDN switch 20, which is beyond a limit of a memory, no more flow may be recorded. However, in the present disclosure, if an occupancy level of a flow table is beyond a predetermined threshold, a management mechanism, such as reducing a timeout of a flow entry that is newly added, flushing out replaceable entries, or the like may be applied. In this manner, a flow table may be managed efficiently even in a case where a flooding attack occurs by a malignant user or by a user's mistake.

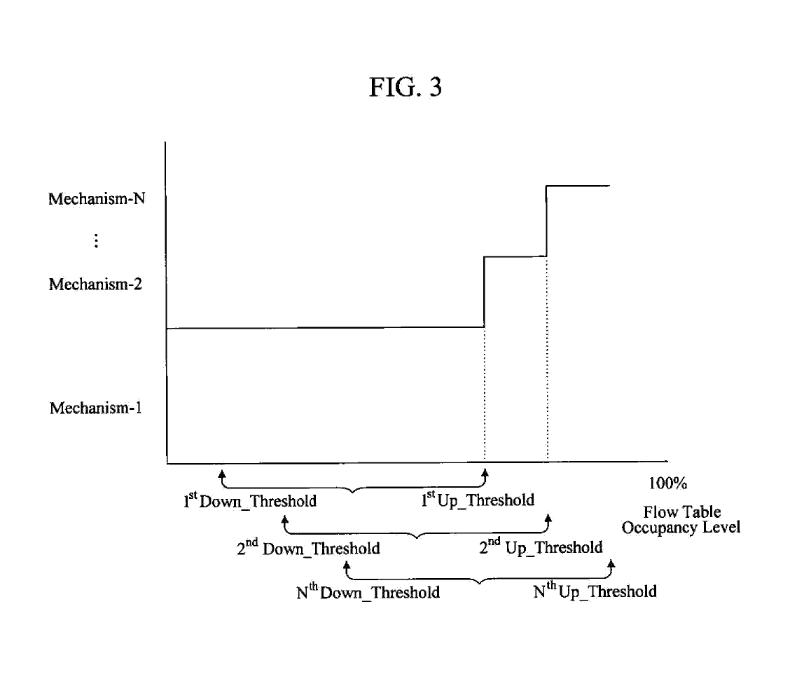

FIG. 3 is a block diagram illustrating an example of a flow table management mechanism differentiated depending on occupancy levels of a flow table according to an exemplary embodiment.

Referring to FIG. 3, a flow table may be divided into a plurality of zones according to occupancy levels of the flow table, and a pair of an upper threshold limit and a lower threshold limit for each of the zones may be configured. For example, as illustrated in FIG. 3, based on occupancy levels of a flow table, a first zone may be configured to have a first upper threshold limit and a first lower threshold limit as a pair, a second zone may be configured to have a second threshold upper limit and a second lower threshold limit as a pair, and an nth zone may be configured to have an nth threshold limit and an nth lower threshold limit as a pair. Each of the zones may or may not overlap each other.

Taking as an example a flow table management mechanism that is differentiated for each of the zones, the SDN controller applies flow table management mechanism 1 to the SDN switch until a first upper threshold limit of a first zone is reached. Then, once an occupancy level of a flow table is beyond the first upper threshold limit, the SDN controller applies flow table management mechanism 2 to the SDN switch until a second upper threshold limit is reached. Then, once an occupancy level of a flow table is beyond the second upper threshold limit, the SDN controller applies flow table management mechanism N to the SDN switch. However, the above example described above with reference to FIG. 3 is merely an illustrative example to assist in understanding of the present disclosure, and various modifications of the flow table management mechanism may be made according to occupancy levels of a flow table.

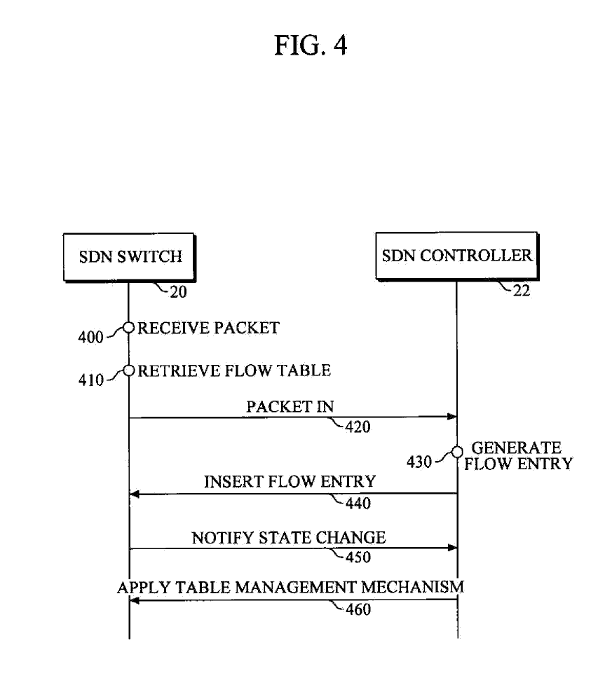

FIG. 4 is a flowchart illustrating an example of a method for managing a flow table according to an exemplary embodiment.

Referring to FIG. 4, upon receiving a new packet in 400, the SDN switch 20 refers to a flow table to retrieve a flow entry matching the received packet in 410. If there is no flow entry that matches the received packet, the SDN switch 20 transmits the received packet to the SDN controller 22 in 420. It is called a Packet_IN in OpenFlow that the SDN controller 22 receives a received packet from the SDN switch 20.

Upon receiving a Packet_IN message from the SDN switch 20, the SDN controller 22 generates a new flow entry in 430 to process a received packet, and instructs the SDN switch 20 to add the generated flow entry. More specifically, the SDN controller 22 inserts a new flow entry at an insertion point of the flow table 200 in 440 by a flow table management mechanism designated by the SDN controller 22. The insertion point may be a head or a tail of a flow table according to types of a flow table, management mechanism, or may be other points. Then, the SDN switch 20 configures a flow table to which a new flow entry is added.

In a case where an event of adding or removing a flow entry occurs, the SDN switch 20 transmits an event message in 450 to the SDN controller 22 to notify occurrence of an event. Alternatively, if a state of a flow table is changed while regularly checking states of a flow table, for example, if an occupancy level of a flow table is beyond a predetermined threshold, the SDN switch 20 transmits an event message that notifies occurrence of an event to the SDN controller 22. The predetermined threshold may be an upper threshold limit or a lower threshold limit of each zone. In response to the notification message, the SDN controller 22 applies a flow table management mechanism in 460 that is appropriate to a state of a flow table to the SDN switch 20.

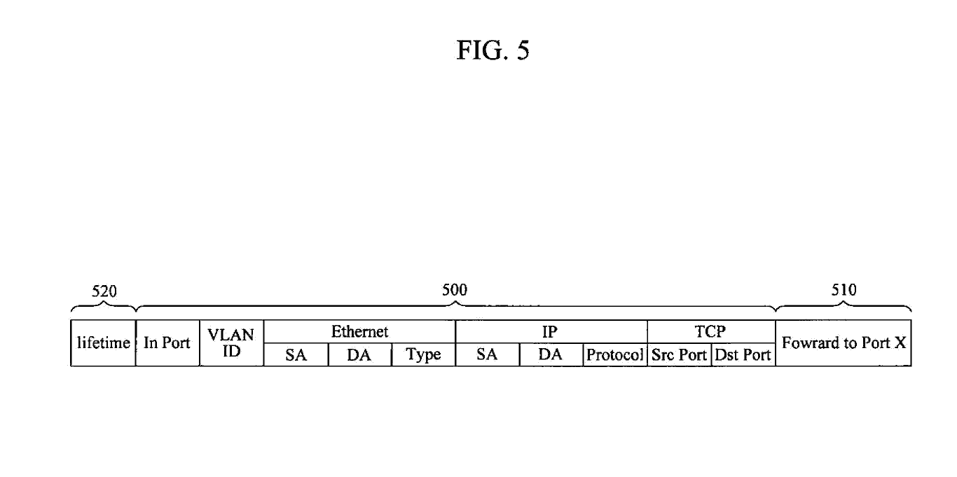

FIG. 5 is a flowchart illustrating a structure of a flow entry to which a timeout is applied according to an exemplary embodiment.

Referring to FIG. 5, flow entries include fields of a rule 500, an action 510, and a timeout 520.

As defined in the OpenFlow, the rule 500 includes flow identifiers such as a destination address (DA), a source address (SA), a destination port (Dst Port), a source port (Src Port), and the like included in a header field of each protocol layer of packets. The action 510 indicates how packets are processed, for example, instructs to forward a packet to port X, as illustrated in FIG. 5.

The timeout 520 refers to a remaining time during which a flow entry may remain in a flow table before being removed therefrom. The timeout 520 is determined by the SDN controller, which may determine not only a length of the timeout 520 but also its types. For example, a hard timeout or an idle timeout may be determined, in which the hard timeout refers to an absolute time during which a flow entry may remain in a flow table, and the idle timeout refers to a time during which a flow entry may remain in a flow table in a case where the flow entry is no longer used.

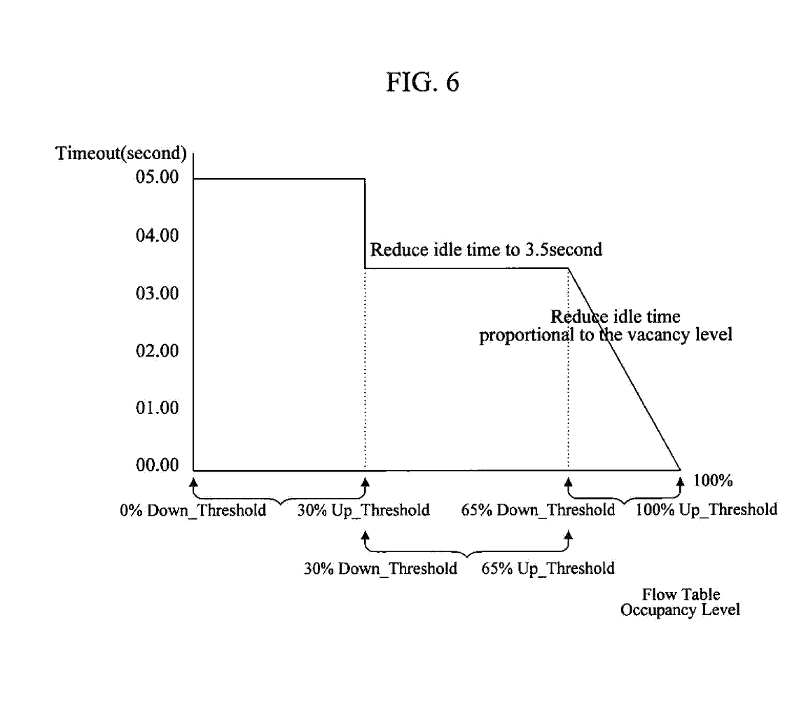

FIG. 6 is a graph illustrating a flow table management mechanism using an idle timeout of a flow entry according to an exemplary embodiment.

Referring to FIG. 6, upon receiving a packet first, the SDN switch refers to a flow table to retrieve a flow entry matching the received packet. If there is no flow entry that matches the received packet, the SDN switch 20 transmits the received packet to the SDN controller 22. Then, the SDN controller 22 generates a new flow entry to process a received packet, and instructs the SDN switch 20 to add the generated flow entry. The new flow entry is inserted at a predetermined insertion point of a flow table.

Subsequently, while checking occupancy levels of a flow table, if an occupancy level of a flow table is changed, the SDN switch notifies the SDN controller of the change of an occupancy level. For example, as illustrated in FIG. 6, a flow table has a first zone with a lower threshold limit of 0% and an upper threshold limit of 30%, a second zone with a lower threshold limit of 30% and an upper threshold limit of 65%, and a third zone with a lower threshold limit of 65% and an upper threshold limit of 100%, according to occupancy levels of the flow table. In this case, the SDN controller sets an idle timeout to be 5 seconds for a newly generated flow entry in the first zone of an occupancy level of 0% to 30%, as illustrated in FIG. 6. Then, if an occupancy level reaches the 30% level, and is from the 30% limit to 65% in the second zone, the SDN controller deducts an idle time of 1.5 seconds from a predetermined idle timeout for the newly generated flow entry. Then, if an occupancy level reaches the 65% level, and is from 65% to 100% in the third zone, the SDN controller reduces an idle time proportionately with an increased occupancy level, or flushes out the newly generated flow entry. That is, the timeout may be gradually reduced to 0, or may be removed immediately. The example described above with reference to FIG. 6 is merely an illustrative example to assist in understanding of the present disclosure, and various modifications of the flow table management mechanism may be made according to thresholds set for each of the zones and change of zones.

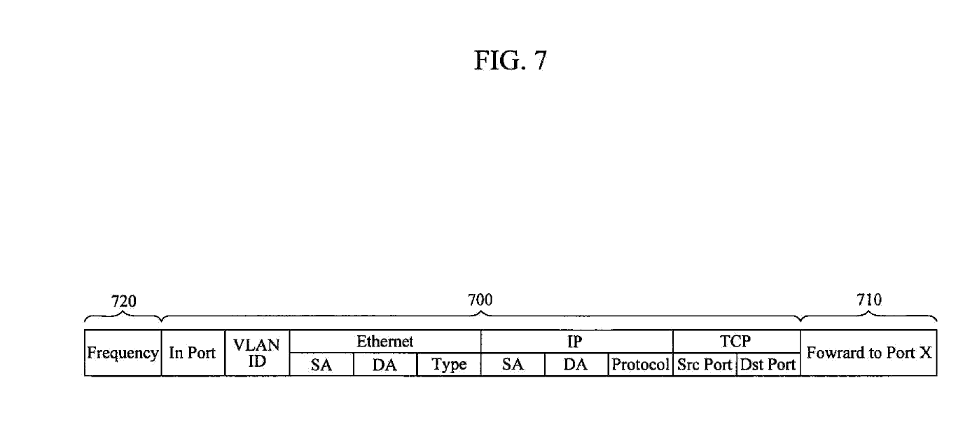

FIG. 7 is a flowchart illustrating an example of a flow entry structure to which usage frequency is applied according to an exemplary embodiment.

Referring to FIG. 7, the flow entries include fields of a rule 700, an action 710, and a frequency 720.

As defined in the OpenF low, the rule 700 includes flow identifiers, such as a destination address (DA), a source address (SA), a destination port (Dst Port), a source port (Src Port), and the like included in a header field of each protocol layer of packets. The action 710 indicates how packets are processed, for example, instructs to forward a packet to port X, as illustrated in FIG. 7.

The frequency 720 refers to usage frequency of flow entries. The frequency 720 may be increased at every time of matching flow entries. If an idle timeout elapses, the frequency 720 may be reduced or initialized. Based on the frequency 720, flow entries may be divided into active flow entries and replaceable flow entries. For example, if beyond a predetermined active value, flow entries may be classified into active flow entries, and if not beyond a predetermined active value, flow entries may be classified into replaceable flow entries. Based on the types of divided flow entries, the SDN controller manages flow entries differently by, for example, protecting active flow entries while flushing out or overwriting replaceable flow entries.

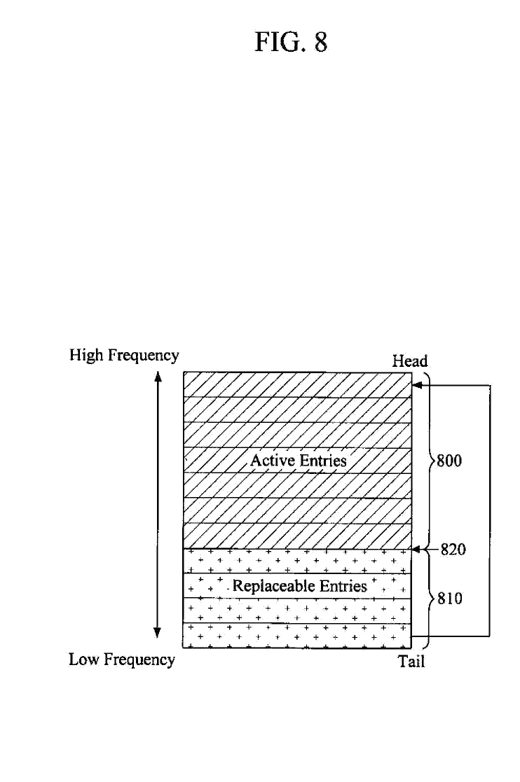

FIG. 8 is a graph illustrating a flow table management mechanism using usage frequency of flow entries according to an exemplary embodiment.

Referring to FIG. 8, upon receiving a packet first, the SDN switch refers to a flow table to retrieve a flow entry matching the received packet. If there is no flow entry that matches the received packet, the SDN switch 20 transmits the received packet to the SDN controller 22. Then, the SDN controller 22 generates a new flow entry to process a received packet, and instructs the SDN switch 20 to add the generated flow entry. The new flow entry is inserted at a predetermined insertion point of a flow table.

In an exemplary embodiment, a new flow entry is not inserted at a tail at the bottom of replaceable flow entries 810, but is inserted at an insertion point 820 between the replaceable flow entries 810 and the active flow entries 800 as illustrated in FIG. 8. If a new flow entry is inserted at a tail of the replaceable flow entries 810, even the active flow entries 800 may be flushed out as new flow entries enter continuously. Therefore, in order to prevent such occurrence, a new flow entry is inserted at the insertion point 820 other than a tail of the replaceable flow entries 810.

In an exemplary embodiment, frequency is increased every time a specific flow entry is used. Further, at a specific interval, for example, at every 5 seconds, frequency may be initialized or reduced. With the increase or decrease of frequency of a specific flow entry, flow entries may be classified as the active flow entries 800 or the replaceable flow entries 810.

Once an occupancy level of a flow table increases to reach a predetermined threshold, the SDN controller protects the active flow entries, and flushes out the replaceable flow entries or overwrites the replaceable flow entries with new flow entries.

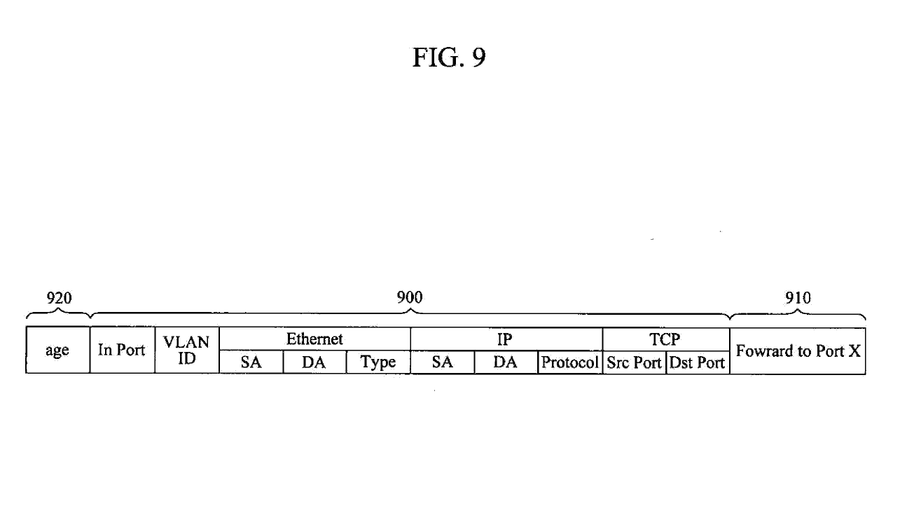

FIG. 9 is a diagram illustrating a flow entry structure to which an age is applied according to an exemplary embodiment.

Referring to FIG. 9, flow entries include fields of a rule 900, an action 910, and a timeout 920.

As defined in the OpenF low, the rule 900 includes flow identifiers, such as a destination address (DA), a source address (SA), a destination port (Dst Port), a source port (Src Port), and the like included in a header field of each protocol layer of packets. The action 910 indicates how packets are processed, for example, instructs to forward a packet to port X as illustrated in FIG. 9.

The timeout 920 refers to a remaining time during which a flow entry may remain in a flow table. For example, if the timeout 920 is 50 seconds with a remaining time of 5 seconds, this indicates that a packet is received at least every 5 seconds, and a flow entry remaining in a flow table for an extended period of time may be an important factor to determine whether it is a valid flow under certain circumstances.

Hereinafter, a flow table management mechanism according to the timeout 920 of flow entries will be described.

First, upon receiving a packet first, a flow entry matching the received packet is retrieved by reference to a flow table. If there is no flow entry that matches the received packet, the SDN switch 20 transmits the received packet to the SDN controller 22. Then, the SDN controller 22 generates a new flow entry to process the received packet, and instructs the SDN switch 20 to add the generated flow entry.

Subsequently, while checking occupancy levels of a flow table, if an occupancy level of a flow table, is changed, the SDN switch notifies the SDN controller of the change of an occupancy level. For example, the SDN switch notifies changes of occupancy levels at occupancy levels of 30%, 65%, and 100%. When notifying a change of occupancy levels at the occupancy level of 30%, the SDN controller does not apply a special mechanism. Further, when notifying a change of occupancy levels at the occupancy level of 65%, the SDN controller does not apply a special mechanism. However, when notifying a change of occupancy levels at the occupancy level of 100%, the SDN switch checks the timeout 920 of each of the flow entries according to an instruction of the SDN controller. The SDN switch flushes out every flow entry, of which timeout is below a predetermined time, e.g. 10 seconds, and protects flow entries, of which timeout is above a predetermined time. In this manner, storage capacity of a flow table may be secured while protecting valid flow entries that remain for an extended period of time under abnormal circumstances, such as a flooding attack and the like. The above example is merely illustrative to assist in understanding of the present disclosure, and various modifications of the flow table management mechanism may be made.

A flow table may be managed by a combination of the flow table management mechanisms described above with reference to FIGS. 5 to 9. For example, in a case where the SDN transmits a message notifying that an occupancy level of a flow entry is beyond 30%, the SDN controller applies a mechanism to the SDN switch that reduces a remaining time of the flow entry by 2 seconds. Then, in a case where the SDN transmits a message notifying that an occupancy level is beyond 65%, the SDN controller applies a mechanism to the SDN switch that reduces a remaining time and flushes out replaceable flow entries, of which frequency is below a predetermine level. Further, in a case where the SDN transmits a message notifying that an occupancy level is beyond 100%, the SDN controller applies a mechanism to the SDN switch that reduces a remaining time and flushes out replaceable flow entries, as well as a mechanism to flush out flow entries of which timeout is below 10 seconds. The above example is merely illustrative to assist understanding of the present disclosure, and various modifications of the flow table management mechanism may be made.

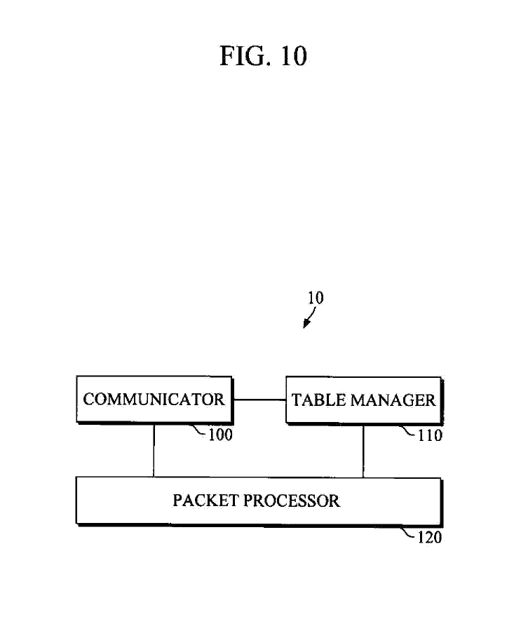

FIG. 10 is a diagram illustrating a network device according to an exemplary embodiment.

The network device 10 is an SDN switch, and a controller that controls the SDN switch may be an SDN controller. Referring to FIG. 10, the network device 10 includes a communicator 100, a table manager 110, and a packer processor 120.

The communicator 100 notifies a controller of a state change of a flow table, and receives a flow table management instruction, in which the changed state of a flow table is reflected, from the controller. The table manager 110 manages a flow table according to the flow table management instruction received through the communicator 100.

The packet processor 120 processes received packets by using a flow table. For example, upon receiving a packet, the packet processor 120 retrieves a flow entry that matches the received packet by reference to a flow table. If there is no flow entry that matches the received packet, the packet processor 120 transmits the received packet to the SDN controller 22 through the communicator 100. By contrast, if there is a flow entry in a flow table that matches the received packet, the packet processor 120 processes the received packet by reference to a flow entry.

In an exemplary embodiment, the table manager 110 manages a flow table in a plurality of states according to occupancy levels of a flow table. For example, based on occupancy levels, a flow table is divided into several zones, and each of the divided zones has a pair of an upper threshold limit and a lower threshold limit. Dividing zones and setting threshold limits of each of the zones are not limited thereto, and may be changed according to network environments.

In an exemplary embodiment, the table manager 110 adjusts a remaining time of flow entries according to occupancy levels of a flow table. For example, if an occupancy level of a flow table is increased such that a state of a flow table is changed, the table manager 110 reduces a remaining time of a newly added flow entry according to a flow table management method instructed by the controller.

More specifically, once an occupancy level of a flow table is increased such that a state of the flow table is changed from a first state to a second state, for example, if an occupancy level becomes 65%, the flow table manager 110 reduces a remaining time of a newly added flow entry by a predetermined time according to a flow table management method instructed by the controller. Further, if a state of a flow table is changed from a second state to a third state, for example, if an occupancy level becomes 90%, the flow table manager 110 reduces a remaining time of a newly added flow entry proportionately with an increased occupancy level, or flushes out the flow entry.

In an exemplary embodiment, the table manager 110 manages flow entries based on usage frequency of flow entries according to occupancy levels of a flow table. For example, if an occupancy level of a flow table is increased such that a state of a flow table is changed, the table manager 110 protects active entries, of which usage frequency is greater than a predetermined active value, and flushes out replaceable flow entries, of which usage frequency is lower than a predetermined active value, or overwrites the replaceable flow entries with new flow entries, according to a flow table management method instructed by the controller.

In an exemplary embodiment, the table manager 110 manages flow entries based on an age of flow entries according to occupancy levels of a flow table. For example, if an occupancy level of a flow table is increased such that a state of a flow table is changed, the table manager 110 protects active entries, of which age is greater than a predetermined time, and flushes out flow entries, of which age is lower than a predetermined time.

According to an exemplary embodiment, states of a flow table in an SDN switch are reflected so that the flow table may be managed adaptively according to its states. Further, even in a case where there is significant changes in a network, or there are many short-term flows in a network, or in a case where flooding attacks occur by a malignant user or due to a user's mistake, a flow table may be managed efficiently.

Particularly, a flow table may be managed optimally by applying various mechanisms for flow table management according to occupancy levels of a flow table. For example, by determining an upper threshold limit and a lower threshold limit for occupancy levels of a flow table, and by applying a flow table management method that is appropriate for a determined upper threshold limit or a lower threshold limit every time the upper threshold limit or the lower threshold limit is reached, a flow table may be managed efficiently and stably without affecting valid flow entries. Further, stability of the SDN may be enhanced, and messages transmitted between an SDN switch and an SDN controller may be reduced.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for managing a flow table, the method comprising:
dividing a flow table into a plurality of states according to occupancy levels of the flow table in a network device;
receiving notification of a state change of the flow table from the network device; and
managing the flow table by reflecting the changed state of the flow table.

2. The method of claim 1, wherein the dividing of the flow table into the plurality of states comprises dividing the flow table into a plurality of zones, and setting thresholds for each of the zones.

3. The method of claim 2, wherein the dividing of the flow table into the plurality of states comprises configuring each of the zones of the flow table to have a pair of an upper threshold limit and a lower threshold limit.

4. The method of claim 1, wherein the receiving of the notification of the state change comprises, in response to an occupancy level of the flow table reaching a predetermined upper threshold limit, receiving a message notifying that the upper threshold limit is reached from the network device, or in response to an occupancy level of the flow table reaching a predetermined lower threshold limit, receiving a message notifying that the lower threshold limit is reached from the network device.

5. The method of claim 1, wherein the receiving of the notification of the state change comprises, in order to prevent jitter, not receiving the notification of the state change from the network device in a case where the network device does not trigger the notification of the state change unless upper threshold has been countered by lower threshold pair and vice versa.

6. The method of claim 1, further comprising:
in response to a state change of the flow table, determining a management mechanism of flow entries included in the flow table according to the changed state; and
transmitting an instruction including the determined management mechanism to the network device.

7. The method of claim 1, further comprising adjusting a timeout of flow entries or flushing out flow entries according to occupancy levels of the flow table.

8. The method of claim 1, further comprising managing flow entries based on usage frequency of flow entries according to occupancy levels of the flow table.

9. The method of claim 1, further comprising managing flow entries based on an age of flow entries according to occupancy levels of the flow table.

10. The method of claim 1, further comprising inserting a new flow entry between inactive (i.e., replaceable) flow entries and active flow entries that are classified according to usage frequency or hit rate.

11. The method of claim 1, further comprising:
setting characteristics of flow entries included in the flow table in the network device;
dividing the flow table into a plurality of states according to occupancy levels of the flow table; and
determining characteristics of the set flow entries by reflecting states of the divided flow table.

12. The method of claim 11, wherein the setting of the characteristics of the flow entries comprises:
setting a hard timeout during which used flow entries remain in the flow table; and
setting an idle timeout during which unused flow entries remain in the flow table.

13. The method of claim 11, wherein the setting of the characteristics of the flow entries comprises:
in response to a flow entry that matches a received packet being present in the flow table, increasing usage frequency of the flow entry; and
initializing or reducing the usage frequency of the flow entry after an elapse of a predetermined time period.

14. The method of claim 13, wherein the setting of the characteristics of the flow entries further comprises:
setting the flow entry as an active flow entry in response to the usage frequency of the flow entry being greater than a predetermined active value according to an increase and decrease of the usage frequency of the flow entry; and
setting the flow entry as a replaceable flow entry in response to the usage frequency being lower than a predetermined active value.

15. The method of claim 11, wherein the setting of the characteristics of the flow entries comprises setting an age during which flow entries remain in the flow table.

16. The method of claim 11, wherein the setting of the characteristics of the set flow entries comprises, in response to a state of the flow table being changed by an increased occupancy level of the flow table, reducing a timeout of a newly added flow entry or flushing out the flow entry.

17. The method of claim 16, wherein the setting of the characteristics of the set flow entries comprises:
in response to the state of the flow table being changed from a first state to a second state by the increased occupancy level of the flow table, reducing the timeout of the newly added flow entry by a predetermined time period; and
in response to the state of the flow table being changed from a second state to a third state by the increased occupancy level of the flow table, reducing the timeout of the newly added flow entry proportionately with the increased occupancy level of the flow table, or flushing out the flow entry.

18. A method for managing a flow table, the method comprising:
dividing a flow table into a plurality of states according to occupancy levels of the flow table in a network device; and
determining processing methods by using characteristics of flow entries according to the states of the divided flow table.

19. The method of claim 18, wherein the determining of the processing method of the low entries comprises:
in response to a state of the flow table being changed by an increased occupancy level of the flow table, identifying usage frequency of each of the flow entries included in the flow table;
protecting active entries, of which the identified usage frequency is greater than a predetermined active value; and
flushing out replaceable flow entries, of which the identified usage frequency is lower than the predetermined active value, or overwriting the replaceable flow entries with new flow entries.

20. The method of claim 18, wherein the determining of the processing method of the low entries comprises:
in response to a state of the flow table being changed by an increased occupancy level of the flow table, identifying an age of each of the flow entries included in the flow table;
protecting flow entries, of which the identified age is greater than a predetermined time; and
flushing out flow entries, of which the identified age is lower than the predetermined time.
